(19) United States
(12) Patent Application Publication
(10) Pub. No.: US 2016/0004521 A1
(43) Pub. Date: Jan. 7, 2016

(54) SYSTEM AND METHOD OF PROVIDING CONTEXT SENSITIVE HELP FOR ALARM SYSTEM INSTALLATION

(71) Applicant: Honeywell International Inc., Morristown, NJ (US)

(72) Inventors: Arthur Tony Park, Kilmarnock (GB); Russell Raeside, Motherwell (GB); Robert John Probin, Glasgow (GB)

(21) Appl. No.: 14/322,197

(22) Filed: Jul. 2, 2014

(51) Int. Cl. G06F 9/445; H04L 29/08; G06F 3/0484

(52) U.S. Cl. CPC G06F 8/61; G06F 8/65; G06F 3/04842; H04L 67/10

(57) ABSTRACT

Systems and methods of providing context sensitive help for alarm system installation are provided. Methods can include the alarm system transmitting a first piece of information to a smart device responsive to an event, where the first piece of information can include information displayed on a user interface of the alarm system or an alternative representation of the information displayed on the user interface of the alarm system. Methods can also include the smart device receiving the first piece of information, the smart device identifying and retrieving a second piece of information associated with the first piece of information, and the smart device displaying the second piece of information on a user interface of the smart device.

### FIELD

The present invention relates generally to the installation of alarm systems. More particularly, the present invention relates to a system and method of providing context sensitive help for alarm system installation.

### BACKGROUND

Installing a commercial alarm system is a complex process that is often undertaken via a simple user interface that consists of a keypad with sixteen keys and a 2×16 character alphanumeric LCD display. However, in some cases, such a display is insufficient to present and provide fully satisfactory feedback regarding the installation process. Furthermore, in all cases, it is impossible to display explanatory text on such a display.

In view of the above, there is a continuing, ongoing need for an improved system and method for alarm system installation.

### BRIEF DESCRIPTION OF THE DRAWINGS

FIG. 1 is a flow diagram of a method in accordance with disclosed embodiments; and

FIG. 2 is a block diagram of a system in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein include a system and method of providing context sensitive help for alarm system installation. However, it is to be understood that systems and methods disclosed herein do not limit the alarm system or the alarm system user interface. For example, the alarm system can be installed and configured independent of the systems and methods disclosed herein, and the alarm system user interface can function independent of the systems and methods disclosed herein.

Some embodiments disclosed herein can provide context specific installation help, on demand, by employing a smart phone, tablet device, or other personal digital assistant. For example, in some embodiments, a user, for example, an installation engineer, can press a key or a combination of keys on a user interface of the alarm system, for example, a keypad of the alarm system. Upon pressing such key or combination of keys, systems and methods disclosed herein can cause the alarm system and/or the alarm system user interface to communicate with the user's smart phone, tablet device, or other personal digital assistant and cause the smart phone, tablet device, or other personal digital assistant to display thereon certain additional information related to the alarm system. For example, the smart phone, tablet device, or other personal digital assistant can display information, such as installation instructions, help, hints, and/or user tips, related to information that is displayed on the user interface and/or display of the alarm system.

In some embodiments, a user need not press any keys on the user interface of the alarm system to cause the alarm system to communicate with the user's smart phone, tablet device, or other personal digital assistant. Rather, in some embodiments, the alarm system and/or the user interface of the alarm system can continuously, periodically at predetermined intervals, and/or upon detecting a predetermined condition, communicate with the user's smart phone, tablet device, or other personal digital assistant and cause the smart phone, tablet device, or other personal digital assistant to display thereon certain additional information related to the alarm system.

In accordance with disclosed embodiments, executable control software can run in or on the alarm system and/or the user interface of the alarm system. Such software can facilitate a connection to and communication with a user's smart phone, tablet device, or other personal digital assistant. For example, the executable control software disclosed herein running on the alarm system can cause the alarm system to transmit information to the user's smart phone, tablet device, or other personal digital assistant. In some embodiments, the connection and communication between the alarm system and the user's smart phone, tablet device, or other personal digital assistant can include any communication path that is supported by both the alarm system and the user's device as would be known by one of ordinary skill in the art. For example, the communication path can include SMS messaging or TCP/IP via local networks, such as WiFi or Bluetooth, or via the Internet, including WiFi or 3G.

In accordance with disclosed embodiments, a software application can run on the user's smart phone, tablet device, or other personal digital assistant. Such a software application can facilitate the connection to and communication with the alarm system and can process data received from the alarm system. For example, the software application disclosed herein running on the user's smart phone, tablet device, or other personal digital assistant can interpret data or other information received from the alarm system to identify and display corresponding additional information, for example, help files or the like that correspond to data or information received from the alarm system.

In accordance with disclosed embodiments, a server can store the corresponding additional information, for example, in a database, and the corresponding additional information can be identified by cross-referencing the information received from the alarm system. In some embodiments, the server can run locally on the user's smart phone, tablet device, or other personal digital assistant. However, in some embodiments, the server can include a remote server that can be accessed in real time, via wireless communication, by the smart phone, tablet device, or other personal digital assistant.

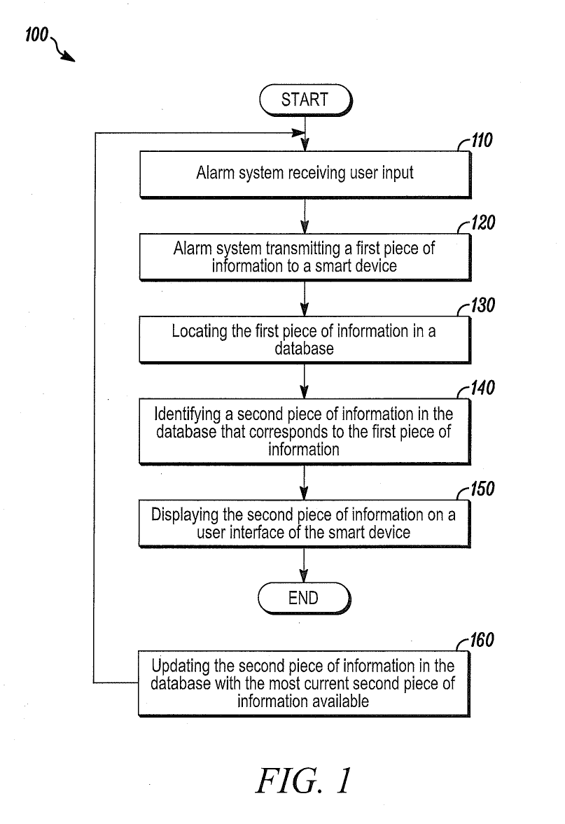

FIG. 1 is a flow diagram of a method 100 in accordance with disclosed embodiments. As seen in FIG. 1, the method 100 can include an alarm system receiving user input as in 110. Responsive to receiving the user input as in 110, the method 100 can also include the alarm system transmitting a first piece of information to a user's smart device, for example, a smart phone, tablet device, or other personal digital assistant, as in 120. In some embodiments, the first piece of information can include information about the current state of the alarm system and/or the user interface of the alarm system and/or at least some information currently displayed on the user interface of the alarm system and/or an alternative representation of the information currently displayed on the user interface of the alarm system.

In some embodiments, the method 100 can transmit the first piece of information to the user's smart device as in 120 absent the alarm system receiving user input as in 110. For example, in some embodiments, the method 100 can transmit the first piece of information to the user's smart device as in 120 continuously, periodically at predetermined intervals, or upon detecting a predetermined condition, for example, upon detecting that the user's smart device is within a predetermined distance from the alarm system and/or the user interface of the alarm system or upon detecting that the user's smart device has entered a predetermined state. In some embodiments, the user's smart device can receive user input to enter the predetermined state.

Regardless, after the method 100 transmits the first piece of information to the user's smart device as in 120, the method 100 can include locating the first piece of information in a database as in 130 and identifying a second piece of information in the database that corresponds to and/or is associated with the first piece of information as in 140. Then, the method 100 can include displaying the second piece of information on a user interface of the smart device as in 150.

In some embodiments, the method 100 can also include updating the second piece of information in the database with the most current second piece of information available as in 160. Accordingly, the method 100 can continuously provide current second pieces of information rather than outdated information that may no longer be useful or relevant to a user.

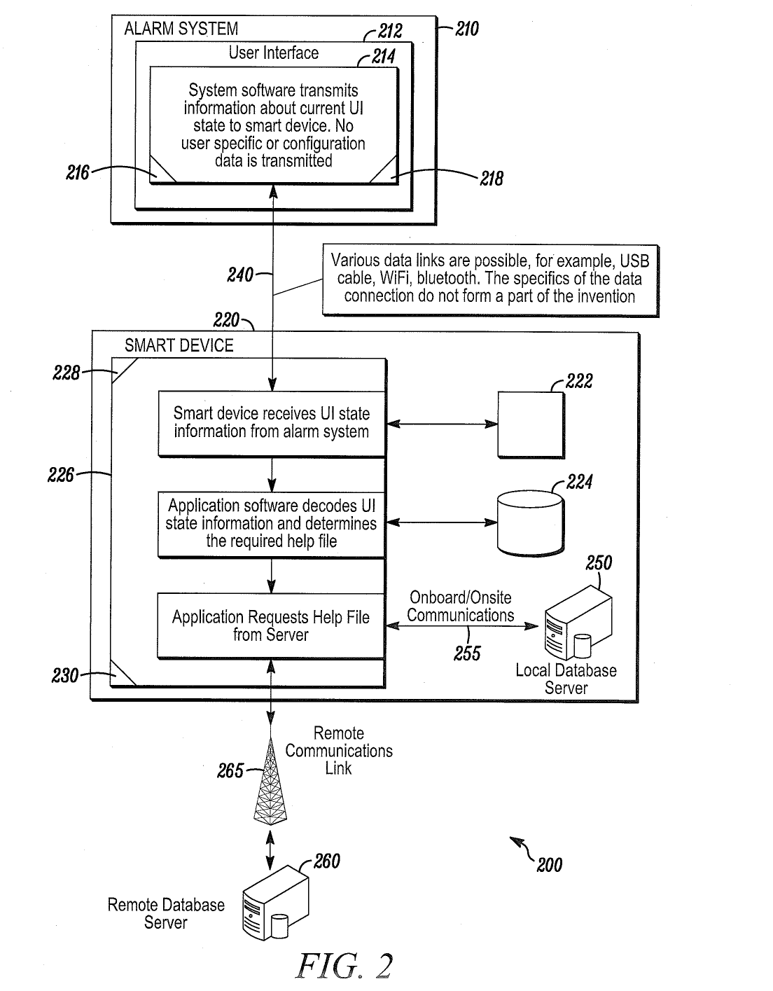

FIG. 2 is a block diagram of a system 200 in accordance with disclosed embodiments. In some embodiments, the system 200 can execute the method 100 of FIG. 1 and others in accordance with disclosed embodiments.

The system 200 can include an alarm system 210 that includes a user interface 212. The user interface 212 can include control circuitry 214, one or more programmable processors 216, and executable control software 218 as would be understood by one of ordinary skill in the art. The executable control software 218 can be stored on a transitory or non-transitory computer readable medium, including, but not limited to, local computer memory, RAM, optical storage media, magnetic storage media, flash memory, and the like. In some embodiments, the control circuitry 214, the programmable processor 216, and/or the executable control software 218 can execute and control at least some of the method 100 and others in accordance with disclosed embodiments.

The system 200 can also include a smart device 220, for example a smart phone, a tablet device, or other personal digital assistant. The smart device 220 can include a user interface 222, a memory device 224, control circuitry 226, one or more programmable processors 228, and an executable control software application 230 as would be understood by one of ordinary skill in the art. The executable control software application 230 can be stored on a transitory or non-transitory computer readable medium, including, but not limited to, local computer memory, RAM, optical storage media, magnetic storage media, flash memory, and the like. In some embodiments, the control circuitry 226, the programmable processors 228, and/or the executable control software application 230 can execute and control at least some of the method 100 and others in accordance with disclosed embodiments.

As seen, responsive to receiving user input and/or continuously, periodically at predetermined intervals, or upon detecting a predetermined condition, the control circuitry 214, the programmable processor 216, and/or the executable control software 218 can transmit information about the current state of the alarm system 210 and/or the user interface 212 of the alarm system 210 to the smart device 220 via a data link 240. For example, the data link 240 can include a USB cable, WiFi, Bluetooth, and the like.

Upon receiving the information from the alarm system 210, the control circuitry 226, the programmable processors 228, and/or the executable control software application 230 can decode the information from the alarm system 210 and identify, determine, and/or locate an information file associated with the information from the alarm system 210. For example, in some embodiments, the control circuitry 226, the programmable processors 228, and/or the executable control software application 230 can access a database, for example, a database stored in the memory device 224 to identify, determine, and/or locate the information file associated with the information from the alarm system 210. Then, the control circuitry 226, the programmable processors 228, and/or the executable control software application 230 can request the information file from a server 250 or 260.

In some embodiments, a server 250 can be stored locally on the smart device 220, and the control circuitry 226, the programmable processors 228, and/or the executable control software application 230 can communicate with the server 250 via onboard and/or onsite communication means 255 as would be understood by one of ordinary skill in the art. However, in some embodiments, a server 260 can be located remotely from the smart device 220, and the control circuitry 226, the programmable processors 228, and/or the executable control software application 230 can communicate with the server 260 via remote communication means 265, for example, wireless communication means such as radio, WiFi, cellular, and the like, or wired communication means such as Ethernet, fiber optics, and the like.

The server 250 or 260 can transmit the requested information file to the control circuitry 226, the programmable processors 228, and/or the executable control software application 230 for displaying information in the requested information file on the user interface 222. Information files stored on the server 250 or 260 can be updated by a user periodically and/or as needed so that the information file transmitted to the control circuitry 226, the programmable processors 228, and/or the executable control software application 230 includes the most current information associated with the information received from the alarm system 210.

Although a few embodiments have been described in detail above, other modifications are possible. For example, the logic flows described above do not require the particular order described, or sequential order, to achieve desirable results. Other steps may be provided, or steps may be eliminated, from the described flows, and other components may be added to, or removed from, the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the sprit and scope of the invention.

What is claimed is:

1. A method comprising:
receiving a first piece of information responsive to an event, the first piece of information including information displayed on a first user interface of a first system or an alternative representation of the information displayed on the first user interface of the first system;
identifying and retrieving a second piece of information associated with the first piece of information; and
displaying the second piece of information on a second user interface.

2. The method of claim 1 wherein the event includes the first user interface receiving user input, and responsive to the first user interface receiving the user input, the first system transmitting the first piece of information.

3. The method of claim 1 wherein receiving the first piece of information responsive to the event includes the first system continuously or periodically transmitting the first piece of information.

4. The method of claim 1 wherein the event includes the first system detecting a predetermined condition, and responsive to the first system detecting the predetermined condition, the first system transmitting the first piece of information.

5. The method of claim 4 wherein the first system detecting the predetermined condition includes the first system detecting the second user interface within a predetermined distance of the first system.

6. The method of claim 4 wherein the first system detecting the predetermined condition includes the first system detecting a second system entering a predetermined state, wherein the second system includes the second user interface.

7. The method of claim 6 further comprising the second user interface receiving user input instructing the second system to enter the predetermined state.

8. The method of claim 1 wherein identifying the second piece of information associated with the first piece of information includes locating the second piece of information stored in a database or on a server.

9. The method of claim 8 further comprising updating the second piece of information stored in the database or on the server.

10. The method of claim 1 wherein identifying the second piece of information associated with the first piece of information includes cross-referencing the first piece of information in a database or on a server.

11. A system comprising:
a first user interface;
a programmable processor; and
executable control software stored on a non-transitory computer readable medium,
wherein the programmable processor and the executable control software receive a first piece of information responsive to an event, the first piece of information including information displayed on a second user interface of a second system or an alternative representation of the information displayed on the second user interface of the second system,
wherein the programmable processor and the executable control software identify and retrieve a second piece of information associated with the first piece of information, and
wherein the programmable processor and the executable control software instruct the first user interface to display the second piece of information.

12. The system of claim 11 further comprising a database stored in a local memory device, wherein the programmable processor and the executable control software identify the second piece of information in and retrieve the second piece of information from the database.

13. The system of claim 11 further comprising a database stored on a local server device, wherein the programmable processor and the executable control software identify the second piece of information in and retrieve the second piece of information from the database.

14. The system of claim 11 further comprising a database stored on a remote server device, wherein the programmable processor and the executable control software identify the second piece of information in and retrieve the second piece of information from the database.

15. The system of claim 11 wherein the event includes the second user interface receiving user input, and responsive to the second user interface receiving the user input, the second system transmits the first piece of information.

16. The system of claim 11 wherein the second system continuously or periodically transmits the first piece of information.

17. The system of claim 11 wherein the event includes the second system detecting a predetermined condition, and responsive to the second system detecting the predetermined condition, the second system transmits the first piece of information.

18. The system of claim 17 wherein the second system detecting the predetermined condition includes the second system detecting the first user interface within a predetermined distance of the second system.

19. The system of claim 17 wherein the second system detecting the predetermined condition includes the second system detecting a first system entering a predetermined state, wherein the first system includes the first user interface.

20. The system of claim 19 wherein the first user interface receives user input instructing the first system to enter the predetermined state.
